(19) United States
(12) Patent Application Publication
(10) Pub. No.: US 2008/0292149 A1
(43) Pub. Date: Nov. 27, 2008

(54) Image Processing System, Particularly for Images of Implants

(75) Inventor: Volker Rasche, Wellesley, MA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,629

(22) PCT Filed: Jun. 24, 2005
(86) PCT No.: PCT/IB2005/052093

§ 371 Date: Dec. 14, 2006

(30) Foreign Application Priority Data
Jun. 28, 2004 (EP) 04300402.7

(51) Int. Cl. G06K 9/00

(52) U.S. Cl. 382/128

(57) ABSTRACT

The invention relates to an image processing system that is adapted to generate a three-dimensional image (32) from projections (P, 31) of a body volume which may for example be generated by a rotational X-ray system (10). The image processing system is further adapted to display on a monitor (30) simultaneously at least one of the original projections (31) and the generated 3D-image (32) together with a superimposed representation of a target region like an implantable stent. The user may then change the dimensions and the shape of the target region in any of the displayed images (31, 32) and watch the results in all images (31, 32). As the original projections (31) are free of errors generated by the reconstruction and visualization of the 3D-image (32), their consideration yields an improved geometrical accuracy.

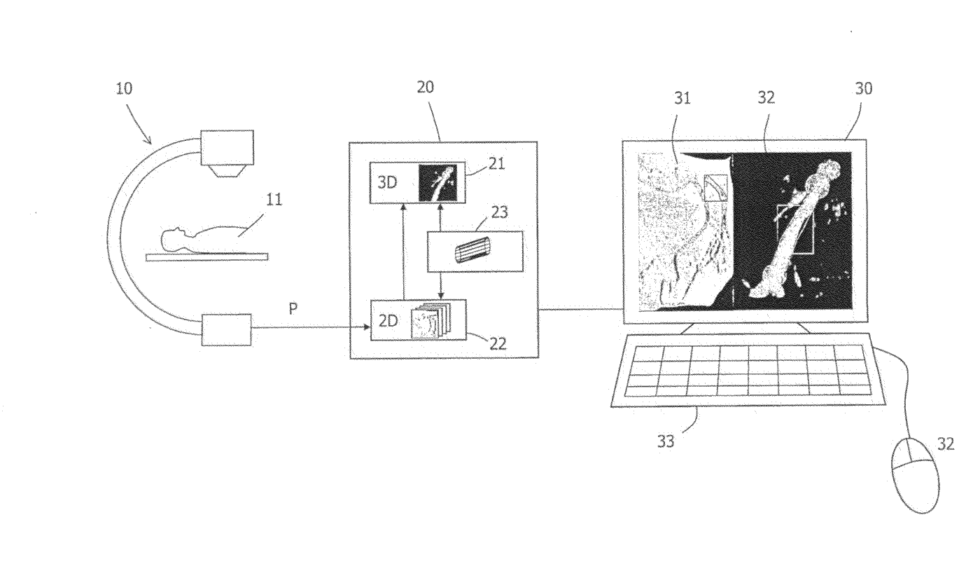

### FIELD OF THE INVENTION

The invention relates to an image processing system with a display unit and a data processing unit that is adapted for interactive evaluation of projections of a body volume, an examination apparatus with such an image processing system, and a method for the interactive evaluation of projections of a body volume.

### BACKGROUND OF THE INVENTION

From the U.S. Pat. No. 5,760,092 a system for the surgical planning of the replacement of a bone prosthesis is known which uses the display of sectional images together with a three-dimensional (3D-) image of the bone, wherein all displayed images are reconstructed from X-ray projections. The cavity that has to be cut into the bone may then be observed and defined by a physician simultaneously on both the sectional images and the 3D-image. The physician may manipulate a model of the cavity on any of the displayed images, while the representations of the model are updated on all images simultaneously.

### SUMMARY OF THE INVENTION

Based on this situation it was an object of the present invention to provide means for a more accurate evaluation of projections from a body volume, particularly in connection with the consideration of implantable devices like stents.

This object is achieved by an image processing system according to claim 1, an examination apparatus according to claim 7, and a method according to claim 8. Preferred embodiments are disclosed in the dependent claims.

The image processing system according to the present invention comprises a display unit, for example a monitor, and a data processing unit, for example a computer with the usual components like central processing unit, volatile and/or nonvolatile memory, I/O interfaces, and appropriate software stored in memory. The image processing system is adapted to execute the following steps:

a) Generation of a 3D-image of a body volume (e.g. the heart of a patient) from projections of the body volume. Said projections may for example be produced by X-radiation. If there are enough projections that map the body volume from different directions, a three-dimensional representation of the body volume may be reconstructed. Methods for such a reconstruction are well known in the field of computed tomography.
b) Determination of the spatial position of a target region on the projections and the 3D-image. The target region may in general be any spatial structure of interest that is or that shall be located in the body volume. A typical example of a target region is an implantable device like a stent that has to be placed in a vessel in order to remedy a stenosis. The target region can for example be represented by a set of three-dimensional coordinates which may be registered with the 3D-image and the projections.
c) Displaying at least one of said projections and said 3D-image simultaneously on the display unit together with a representation of the target region on all displayed images. The target region may for example be represented by its contour or a surface grid in a special color that makes it readily visible on the display. Optionally two or more projections are displayed that correspond to different (preferred orthogonal) directions.

It is known in the state of the art to generate 3D-images from image data like projections produced by an imaging system. Such 3D-images are extremely helpful for a user in order to orientate and navigate in a complex environment like the coronary vessel system of a patient. It was noted, however, that the visualization and processing (e.g. segmentation) of 3D-images may introduce a considerable error with respect to the exact geometry of the mapped body volume because the results depend largely on the right choice of image processing parameters. This may pose severe problems if geometric parameters of the body volume have to measured accurately or if an implantable device has to be adapted for and/or to be positioned in the body volume. In order to improve accuracy in these cases, the image processing system described above allows the simultaneous display of both the original projections and a visualization of the 3D-image that is reconstructed thereof. A user may then simultaneously see the position of a target region, for example a stent, on the 3D-image and on at least one of the original projections. This has the advantage that the 3D-image provides a good idea of the spatial localization of the target region, while the representation of the object on the original projection allows to check if its position and shape fits to the real geometry of the body volume. Errors that are introduced by the algorithms and parameters used for the visualization and/or processing of the 3D-image may thus be detected by the user and can for example be corrected.

As was already mentioned, the target region may be any kind of structure that is of interest for a particular application. Thus, the target region may for example be something that is already present in the body volume like an organ or a part thereof, a cavity, an implanted device or the like. According to a special embodiment of the invention, the image processing system is therefore adapted to determine the target region from the available image data, i.e. basically from the projections of the body volume. This derivation may be based on procedures like segmentation that are well known in the state of the art. A target region that was derived this way may then be represented on the projections and the 3D-image allowing a user to check if the object was correctly determined.

The image processing system is optionally adapted to analyze the target region quantitatively. If the target region is for example a vessel tree that was segmented from the image data, its volume may be determined for diagnostic purposes.

According to another embodiment of the invention, the image processing system comprises an input device like a mouse or a keyboard by which a user may interactively position and/or shape the target region on at least one of the displayed images. Thus the user may for example construct an implantable device that is individually fitted to a patient, or correct a region that was automatically segmented by the system. The user may manipulate the displayed target region in the projections or the 3D-image, whatever is more convenient to him.

According to a further development of the aforementioned embodiment, the data processing unit is adapted to give interactive inputs of a user that concern the target region and that are based on the displayed projections a higher priority than interactive inputs that are based on the displayed 3D-image. If the user for example sets the position of a wall of an implantable device on an original projection of the body volume and later makes inputs on the 3D-image of the body volume that would change the position of said wall, the data processing unit may ignore these changes or may warn the user that the changes are in conflict with the previous inputs on a projection. Thus the projections are given a higher priority reflecting the fact that they represent original information which is not impaired by errors from a three-dimensional processing.

As was already mentioned, the target region may particularly be an implantable device like a stent. The data processing unit may then preferably comprise a data base in its memory that stores data (shapes etc.) of objects to be modeled. Such a data base may particularly be used in connection with implantable devices that have known shapes and dimensions which are provided by the manufacturer.

The invention further comprises an examination apparatus with an imaging system, particularly a (rotational) X-ray device, for generating projections of a body volume, and an image processing system of the kind described above. For more information on details, advantages and further developments of the examination apparatus, reference is therefore made to the description of the image processing system.

Furthermore, the invention concerns a method for the interactive evaluation of projections of a body volume, comprising the following steps:

Generating a 3D-image of the body volume from projections of said volume.

Determination of the position of a target region on the projections and the 3D-image.

Displaying at least one of the projections and the 3D-image simultaneously together with a representation of the target region.

The method comprises in general form the steps that can be executed with an image processing system of the kind described above. Therefore, reference is made to the preceding description for more information on the details, advantages and improvements of that method.

According to further development of the method, the position and/or shape of the target region is interactively determined on the display. In this case it is further preferred that changes which are made on the displayed projections are given a higher priority than changes that are made on the 3D-image. Thus a user may exploit all available information and images in order to define an object, wherein the geometric accuracy is guaranteed by the simultaneous consideration of the original projections.

These and other aspects of the invention will be apparent from and elucidated with reference to the embodiment(s) described hereinafter.

### BRIEF DESCRIPTION OF THE DRAWINGS

In the following the invention is described by way of example with the help of the accompanying drawing which schematically represents an examination apparatus according to the present invention.

### DESCRIPTION OF PREFERRED EMBODIMENTS

The examination apparatus comprises an imaging system 10 which may for example be a rotational X-ray system with a C-arm or a CT-system. The X-ray source and the detector of this system may be rotated around a patient 11, thus generating projections P of a body volume of interest from different directions. These projections P are communicated to a module 22 (e.g. a memory) of an image processing unit 20 which may for example be implemented by a workstation with appropriate software. The image processing unit 20 further contains a module 21 (e.g. comprising software and/or specialized hardware) that is able to reconstruct a three-dimensional (3D-) image of the body volume from the projections P.

The data processing unit 20 is connected to a monitor 30 on which images of the body volume can be displayed.

In the following it is assumed that an implantable device such as a stent or some other implant shall be handled with the help of the images of the body volume. It might for example be desired to measure the dimensions of a stent that is already implanted into the vessel system of a patient, or it might be required to determine the dimensions and shape of a stent that shall be placed into the vessel system.

In case of a three-dimensional representation of a target area, the selection of an implantable device such as a stent or implant can be performed accurately on the basis of the volume image. However, the appearance of the volume visualization heavily depends on the visualization parameters chosen and the artifact level in the image. In case of non-optimal setting of e.g. the threshold value for the visualization or severe image artifacts, the visualization may provide an inaccurate representation. If for example the lower limit of the gray levels is chosen too high, the representation of a vessel may be too thin, while it will be too thick if the limit is chosen too low. The accuracy of the quantitative assessment of the implantable device dimensions, either for the selection of the device or for its automatic or interactive individualized construction, therefore depends on the quality of the visualization.

It is therefore suggested to use both the reconstructed 3D representation of the target region and the original projections P for improved device selection. For that purpose, the device is selected and positioned in the volume representation 32 of the target region (for an abdominal aortic aneurysm e.g. the device can be interactively constructed in 3D, for coronary stents e.g. the devices can be provided from a database 23). Simultaneously with the display of the 3D-image 32 on the monitor 30, the current shape of the device is projected into at least one of the original projections 31 which is displayed on the monitor 30, too. This allows an instantaneous check of the shape of the modeled device in the original projections 31.

To finalize the shape of the device, a user can either interact on the 3D-image 32 (thereby influencing the appearance of the device in all projections 31), or the shape into a single direction can directly be adapted in the projections 31. Depending on where the interaction takes place, the shape is automatically adapted in the other representation.

In another embodiment of the invention, the 2D/3D approach can be used for the assessment of the accuracy of automated extraction of quantitative geometric parameters in 3D (e.g. the volume of a vessel) and optionally for a correction.

In summary, the present invention provides the following advantages:

improved accuracy for implantable device selection;

easier shape adaptation during interactive definition of the device shape;

quick check up of automatically extracted quantitative volumetric parameters.

Finally it is pointed out that in the present application the term “comprising” does not exclude other elements or steps, that “a” or “an” does not exclude a plurality, and that a single processor or other unit may fulfill the functions of several means. Moreover, reference signs in the claims shall not be construed as limiting their scope.

1. An image processing system comprising a display unit (30) and a data processing unit (20), wherein the system is adapted to:
generate a 3D-image (32) of a body volume from projections (P, 31) of said volume;
determine the position of a target region on the projections (P, 31) and the 3D-image (32);
display at least one of the projections (31) and the 3D-image (32) simultaneously on the display unit (30) together with a representation of the target region.

2. The image processing system according to claim 1, characterized in that the target region represents an implantable device, particularly a stent.

3. The image processing system according to claim 1, which is adapted to determine the target region from the available image data, particularly by segmentation.

4. The image processing system according to claim 1, which is adapted to analyze the target region quantitatively.

5. The image processing system according to claim 1, characterized in that it comprises an input device (32, 33) by which a user may interactively position and/or shape the target region on one of the displayed images (31, 32).

6. The image processing system according to claim 1, characterized in that it comprises a data base (23) which stores data of objects to be modeled.

7. Examination apparatus, comprising
an imaging system (10), particularly a rotational X-ray device, for generating projections (P, 31) of a body volume:
an image processing system (20) according to one of claims 1 to 6.

8. A method for the interactive evaluation of projections (P, 31) of a body volume, comprising the steps of
generating a 3D-image (32) of the body volume from projections (P, 31) of said volume;
determination of the position of a target region on the projections (P, 31) and the 3D-image (32);
displaying at least one of the projections (31) and the 3D-image (32) simultaneously together with a representation of the target region.

9. The method according to claim 8, characterized in that the position and/or shape of the target region is interactively changed on a display.

10. The method according to claim 9, characterized in that changes which are based on a displayed projection (31) have a higher priority than changes which are based on the displayed 3D-image (32).
